(19) United States
(12) Patent Application Publication
(10) Pub. No.: US 2021/0229633 A1
(43) Pub. Date: Jul. 29, 2021

(54) BIOMETRIC USER AUTHENTICATING KEYS FOR VEHICLES AND METHODS OF USE

(71) Applicant: Ford Global Technologies, LLC, Dearborn, MI (US)

(72) Inventors: Aaron DeLong, Toledo, OH (US); Ali Hassani, Ann Arbor, MI (US); John Robert Van Wiemeersch, Novi, MI (US); Lawrence Chikeziri Amadi, Chicago, IL (US)

(73) Assignee: Ford Global Technologies, LLC, Dearborn, MI (US)

(21) Appl. No.: 16/751,027

(22) Filed: Jan. 23, 2020

(51) Int. Cl. B60R 25/25; B60R 25/04; B60R 25/24; B60R 25/22

(52) U.S. Cl. CPC B60R 25/252; B60R 25/22; B60R 25/24; B60R 25/04

(57) ABSTRACT

Biometric user authenticating keys for vehicles and methods of use are provided herein. An example method includes obtaining biometric information of a user from a biometric reader incorporated into the device or communicatively coupled with the device, authenticating an identity of the user based on the biometric information, selecting a mode of operation for the vehicle based on the biometric information. The mode of operation can specify vehicle privileges for the user. The method can include transmitting a signal to a vehicle controller of a vehicle to request access to the vehicle or start an engine of the vehicle after the identity of the user has been authenticated.

### FIELD OF INVENTION

The present disclosure is generally directed to biometric-based vehicle access and operation using physical keys.

### BACKGROUND

Automotive equipment manufacturers are introducing smart physical keys. Some manufacturers have introduced options where a user can utilize their smartphone in place of a standard key or keyfob, referred to as Phone-as-a-Key (PaaK). Smart physical keys can be used to associate a particular driver with a profile stored on the vehicle. These features can allow a user to specify vehicle features such as seat and mirror position, or other aesthetic or functional vehicle options. An administrator user, such as a parent, can set up a profile for a second user, such as a child. The subordinate user profile for the child can limit some actions (e.g., vehicle privileges) of the user, such as speed limits, seat belt warnings, infotainment limitations, and so forth. These features can be enabled on a per-key basis, where a user is associated with a unique physical key. Each operator of the vehicle can use their own unique key, or parties can share a single key. Similar features can be implemented through PaaK or other related physical keys.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 depicts another illustrative architecture in which techniques and structures for providing the systems and methods disclosed herein may be implemented.

FIG. 3 is a flowchart of an example method of the present disclosure.

FIG. 4 is a flowchart of another example method of the present disclosure.

FIG. 5 is a flowchart of yet another example method of the present disclosure

### DETAILED DESCRIPTION

### Overview

Device-based key offerings may enable access and start for a vehicle. These device-based key offerings include, but are not limited to, a smart key fob, NFC, and Phone-as-a-Key (PaaK). Each of these devices can offer the user the capability to personalize their experience with a built in vehicle profile, though in an imprecise fashion. Lack of precision in identifying the user can be problematic. A simple example is to consider the selection of the wrong device in shared vehicle. The issue can present itself in two example scenarios, whereby the intended user gains an undesired elevation in driving privileges, and/or the primary user can end up in a restricted mode. Another scenario to consider is vehicle theft. Theft can occur via relay attack or in some cases, simply stealing the vehicle key. In these scenarios, there is no guarantee that the user who is in possession of the key is a valid (e.g., authorized) user. Indeed, the Institute of British Insurers has noted that vehicle theft has increased by 20% annually in the past five years (with digital theft being the primary driver).

The present disclosure is directed to systems and methods that determine an identity of a user of a vehicle through a specifically configured physical key. The physical key can comprise a key fob that includes an integrated biometric reader that can read, for example, a fingerprint or iris of the user. The user can be authenticated using biometric information obtained from the biometric reader. In another example, the physical key can include a smartphone of a user. The biometric reader can also be implemented as a smartcard reader that can be coupled to the smartphone. Alternatively, the smartcard reader can be installed in the vehicle. Rather than using a fingerprint obtained from the integrated biometric reader of a keyfob, the fingerprint (or other biometric information) can be obtained from a smartcard that is inserted into the biometric reader. The smartcard can also function as a touch sensor, for example, allowing for the use of secure digital signatures. Embodiments that include a smartcard option may be advantageous in situations where a legacy physical key or keyfob is utilized. Some implementations allow for a second type of authenticating information, such as a digital signature to be used in combination with the biometric information.

The systems and methods disclosed herein can manage various modes of the vehicle. Prior to authenticating a user to access or start the vehicle, the vehicle or physical key may be placed into a security mode. When challenged, the user can provide their biometric information to gain access or start the vehicle. This places the vehicle into one or more types of modes. One example mode includes an active mode. Other modes include a limited mode, where the user is granted limited vehicle privileges, as well as a shared mode such as when a valet or other shared user is operating the vehicle. The shared mode may also limit vehicle operations, such as speed or travel distance, or disable remote vehicle starting. The user can utilize the physical key to reengage the active mode through a subsequent provision of biometric information when the physical key is in a limited or shared mode. The systems and methods disclosed herein can also be used to reduce malicious vehicle interactions such as man-in-the-middle or relay attacks. When a malicious event is suspected or identified the user can be challenged to provide biometric information that is used to authenticate the identity of the user.

### Illustrative Embodiments

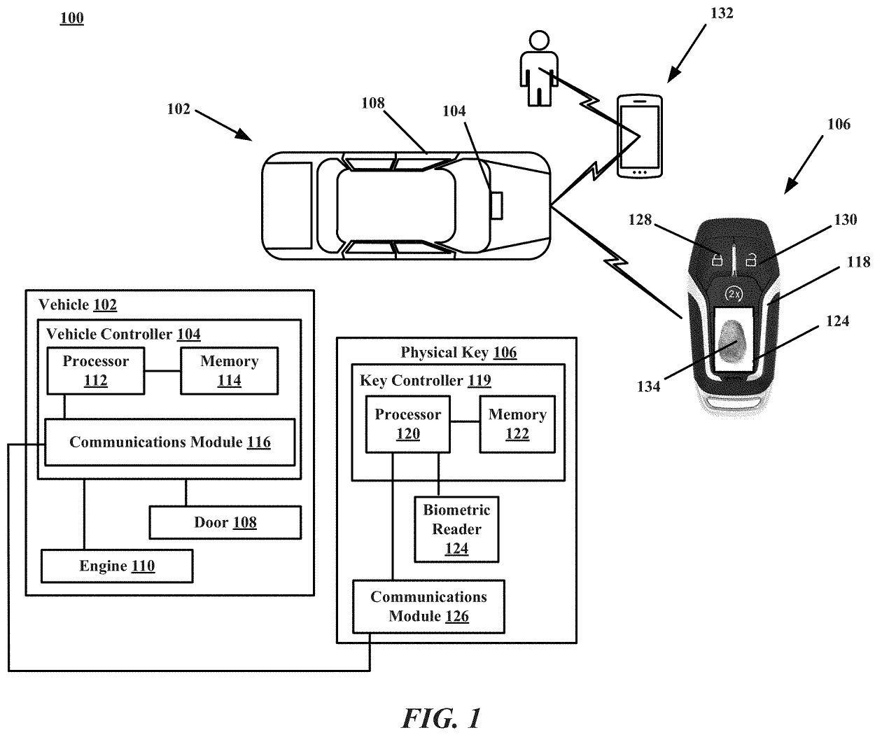

Turning now to the drawings, FIG. 1 depicts an illustrative architecture 100 in which techniques and structures of the present disclosure may be implemented. A vehicle 102 can comprise a vehicle controller 104 and a physical key 106 used to gain access and/or start the vehicle 102. For example, physical key 106 can be used to unlock a door 108 of the vehicle 102. An engine 110 could be started using the physical key 106 as well. Generally, the vehicle controller 104 and the physical key 106 can be used to cooperatively control access and use of the vehicle 102 by one or more users. Example users can include an administrative user who can define limited mode vehicle privileges for other users. For example, a parent can be an administrative user who defines vehicle features for a child, who is a limited user. Another special case limited user can include a shared user, such as valet. An example shared mode could be implemented to prevent remote vehicle starting or confine operation of the vehicle to within a certain defined radius. Thus, the vehicle controller 104 manages user identity verification for physical keys.

The vehicle controller 104 can cooperate with the physical key 106 can ensure that a user with the physical key 106 has been enrolled and approved to use the vehicle 102. These features can also allow a single physical key to be used by multiple users, each of which can be designated to have certain vehicle permissions. Of course multiple physical keys can be used, but the vehicle controller 104 can cooperate with the physical key 106 to authenticate an identity of a user and invoke vehicle privileges for the authenticated user. In some instances, the vehicle controller 104 can cooperate with the physical key 106 to authenticate an identity of a user prior to allowing that user to access or start the vehicle, with or without respect to the management of vehicle privileges.

The vehicle controller 104 can comprise a processor 112 and memory 114. The memory 114 stores instructions that are executed by the processor 112 to perform aspects of biometric authentication, as well as user identity and/or mode management as disclosed throughout. When referring to operations executed by the vehicle controller 104, it will be understood that this includes the execution of instructions by the processor 112. Depending on the configuration of the physical key 106, the vehicle controller 104 can communicate with the physical key 106 through any number of short-range or long-range wireless communications such as Bluetooth, Bluetooth Low Energy, Near-Field Communications, WiFi, cellular, and the like. Generally, the vehicle controller 104 can communicate with the physical key 106 using a communications module 116 that can be configured to utilize any desired communications protocol.

FIG. 1 illustrates one example version of the physical key 106. This physical key 106 can include a housing 118, and a key controller 119 that comprises a processor 120, a memory 122. The key controller 119 can implement identity management logic, power optimization logic, and other features as disclosed herein. The physical key 106 can also comprise a biometric reader 124, and a communications module 126. The communications module 126 can be used to transmit and receive data from the vehicle controller 104. The physical key 106 can also include various buttons, such as button 128, that when pressed, allows the user lock the door 108 and button 130 that user unlock the door 108. The biometric reader 124 can include a touch sensor configured to read a fingerprint of a user. Other embodiments of the physical key and biometric reader will be discussed in greater detail herein.

In operation, the user can begin by enrolling the physical key 106 with the vehicle controller 104. This can include pairing the physical key 106 with the vehicle controller 104. The vehicle controller 104 can provide the user with menus or interfaces that allow the user to create profiles for each user who desires to utilize the physical key 106. Each of the user profiles can be associated with the physical key 106, for example, using a unique identifier for the physical key 106.

The enrollment process can be reserved for an administrative user. The administrative user can also specify the parameters of the various modes that can be implemented using the physical key 106, which include security mode, active mode, limited mode, and/or shared mode. In general, a security mode is invoked to ensure that the vehicle is in a locked or inaccessible state. In the active mode, full vehicle privileges are available. A limited mode can include a reduction of vehicle privileges relative to the active mode. A shared mode can be implemented when a third-party, such as a valet, is given temporary access to operate the vehicle. The shared mode can have different vehicle privileges compared to the limited mode. Each of these various modes can be effectuated using the same physical key 106, which can be used by multiple users.

During enrollment, a user can create a digital touch signature on a surface of the biometric reader 124. This touch signature may be in the form of a timed finger motion activity. For example, the user may draw the figure of a dollar sign or tap along the biometric reader 124 region ‘x’ number of times in a particular order. The pattern of the touch signature can be encoded as a series of vector points (<x, y, i, j, t>: 2D position, direction, and time). Doing so, allows the signature pattern to be correctly recognized when performed format at any location and orientation of the card. Also, this digital signature format allows for a variety of signature patterns which is convenient to the user and allows for personalization. Consequently, the large variety of possible signature patterns makes it harder for bad actors to gain access through multiple trials. Hence, the added complexity makes the physical key 106 more secure.

The one or more user profiles associated with the physical key 106 can be created and stored by the vehicle controller 104 or in a cloud resource. Initially, when the vehicle 102 has been shut down for a period of time, such as when the engine is turned off and the door locked, the vehicle controller 104 can place the vehicle 102 into the security mode.

In general, biometric authentication of a user can occur at the vehicle controller 104 level or alternatively at the physical key 106 level. Examples for each of these options are disclosed in greater detail below. As noted above, in addition to authenticating based on a biometric input such as a fingerprint, the user can be further subjected to a digital signature challenge. The user may be requested to input their digital signature on the biometric reader 124, or on an associated touchscreen. For example, the user can provide their signature through a mobile device 132 within the vehicle 102. To be sure, the mobile device 132 can pair or otherwise communicatively couple with the vehicle controller 104 and/or the physical key 106.

In use cases where the vehicle controller 104 authenticates the user, the authentication process can be initiated in a variety of ways. For example, when a user desires to access or start the vehicle 102, the user can present the physical key 106 near the vehicle 102. In one use case, the vehicle controller 104 can present the physical key 106 with a challenge when the physical key 106 is within proximity to the vehicle 102 or when the user has attempted to access the vehicle 102 using a button of the physical key 106.

In instances where the challenge is presented to the physical key 106 before access to the vehicle 102 is granted, the vehicle controller 104 can transmit a signal to the physical key 106 that prompts the user to provide their biometric information 134, which is illustrated as a fingerprint. For example, a light on the physical key 106 could be illuminated. In another example, a vibrational element inside the housing 118 could be activated. Regardless of the triggering process, when the signal is received from the vehicle controller 104 that prompts a challenge, the user can apply their finger to the biometric reader 124. The key controller 119 can read the biometric information from the biometric reader 124 and transmit the same to the vehicle controller 104.

In response, the vehicle controller 104 can attempt to authenticate the biometric information by first identifying the physical key 106 by its unique identifier. The vehicle controller 104 can attempt to match the biometric information to the various user profiles it has stored. If a match is located, the vehicle controller 104 can grant access to the vehicle 102. For example, the vehicle controller 104 can unlock the door 108, or allow the user to unlock the door 108 with the physical key 106. When no matching profile is found, the challenge fails and the vehicle 102 remains in security mode. If a matching profile is found, the vehicle controller 104 can further apply a specified vehicle mode for the user (as identified in their profile). For example, the vehicle controller 104 can enable active mode or limited mode. It will be understood that shared mode may be activated through a menu (not shown) provided by the vehicle controller 104. In some instances, shared mode can be activated by a user who has active mode privileges or a user who has shared mode privileges.

As noted above, some implementations involve biometric authentication of the user at the physical key 106 level. In these instances, the physical key 106 can be disabled while the vehicle 102 is in the security mode. The physical key 106 may not respond to access or engine start challenges from the vehicle controller 104 until a biometric information authentication process has been completed. Once the user is authenticated, the user can access the vehicle 102. When started, the physical key 106 can be sensed by the vehicle controller 104, and the vehicle privileges for that user are enabled by the vehicle controller 104.

Thus, the modes can be implemented at the physical key 106 level rather than by the vehicle controller 104. In these use cases, the key controller 119 can store the enrolled biometric information of one or more users that are used to subsequently authenticate the one or more users. The physical key 106 may not be enabled to access or start the vehicle 102 until the key controller 119 authenticates the identity of the user through biometric information. Thus, rather than relying on the vehicle controller 104 to authenticate the identity of a user, the key controller 119 can be utilized to authenticate the identity of a user.

In one use case, the physical key 106 can be used to unlock the door 108 of the vehicle 102 without prior identity authentication, but the engine 110 may not be started until the user has been authenticated through the physical key 106 using biometric information. Thus, security mode can be enabled to prevent access to the vehicle or start of an engine of the vehicle. In other use cases, security mode can be enabled only to prevent engine start.

With regard to authentication of biometric information, the key controller 119 can be configured to implement a Bayesian classifier. In some instances, pre-processing of data is used when the key controller 119 is a low power device. Bayesian classifiers are relatively lightweight in computational cost and require minimal features for recognition accuracy. However, with a low resolution device, pre-processing can be implemented to reduce false recognition rates due to noise. A common example of noise may arise when dirt or dust is present on the biometric reader 124. To account for this, the key controller 119 can apply a recognition model that adds additional contrast to gain granularity to images obtained from the biometric reader 124. The key controller 119 can subtract out background data whenever imaging, which includes any part of the biometric information in image form that is not part of a fingerprint, for example. This can include whitespace around the ridges of the fingerprint or around an outer periphery of the fingerprint.

Further accuracy may be gained by applying bilateral filtering (e.g., a heuristic computer vision technique used to remove “salt and pepper noise” from images while retaining edge definition) to remove dust particle impressions from images. Alternatively, a model may be trained to identify dirt and/or dust, and automatically subtract pixels that are occluded from the features.

When a user has been biometrically and/or signature authenticated, the physical key 106 (or vehicle controller 104) can switch from the security mode to the active mode. The key controller 119 can then transmit a signal to the vehicle controller 104 requesting access or engine start, depending on the scenario.

Once authenticated, activation of the active mode can persist, allowing the physical key 106 and the vehicle to remain in an authenticated state for a period of time or for a number of drive cycles. For example, the physical key 106 may remain in an authenticated state for an hour, or for three key-on and/or key-off cycles. These examples are not intended to be limited and other example time frames and drive cycles can be used.

As noted above, the physical key 106 or vehicle 102 can be placed into a limited mode for certain users. When the physical key 106 or vehicle 102 is in the limited mode, an active mode user can reactivate the active mode. For example, an active mode user can provide their biometric information to the biometric reader 124 when the physical key 106 is in a limited mode. This allows the key controller 119 to reactivate the active mode for the active user. For example, full vehicle privileges made available to an active user during active mode are reduced for a limited user during a limited mode. When the active user is authenticated during limited mode, the full vehicle privileges are restored. That is, when biometric information obtained from the biometric reader 124 during a limited mode of operation is determined to be associated with a user who has active mode access, the key controller 119 switches back to the active mode.

In order to reduce power consumption and extend device life, the physical key 106 may implement power optimization by keeping the biometric reader 124 inactive until the physical key 106 is actively challenged by the vehicle controller 104. Power may be supplied actively in some contexts, such as low frequency (LF) or NFC supplying the necessary current to at a minimum wake-up the biometric reader 124 (or if sufficient current can be supplied, actually drive the biometric reader 124).

Alternatively, a wake-up signal could be supplied based off the user manipulating the biometric reader 124. The biometric reader 124 could include a pressure sensitive membrane, piezoelectric transducer, or a hall-effect sensor that senses the presence of the user's finger and temporarily activates the biometric reader 124.

The key controller 119 can also be configured to respond to identity challenges from the vehicle controller 104, for example. That is, the vehicle controller 104 can issue identity challenges to the physical key 106. The physical key 106 can respond with biometric information obtained from the physical key 106. For example, the vehicle controller 104 can detect that an anomaly, such as a relay attack or other similar malicious action has been taken against the vehicle 102 or the physical key 106. Another anomaly could include a man-in-the-middle attack. When the vehicle controller 104 suspects this potential malicious action or other anomaly, the vehicle controller 104 can issue an identity challenge to the physical key 106.

As noted above, the biometrics sensed by the biometric reader 124 can include iris recognition, facial recognition, heartbeat or pulse recognition, voice recognition and so forth. Thus, in some configurations, the biometric reader 124 can comprise a camera that can obtain images of a face (or at least a portion thereof such as an eye) of a user. The images can be processed by the key controller 119 to confirm the biometric signature of the user. In another use case, the biometric reader 124 can comprise an electrical biometric sensor, such as an electrocardiogram monitor. Baseline electrical signatures of the user can be compared against biometric information by the key controller 119 obtained during an authentication challenge. In yet another example use case, the biometric reader 124 could comprise a microphone that obtains voice samples obtained during an authentication challenge. These voice samples can be compared against baseline voice samples by the key controller 119 to authenticate a user.

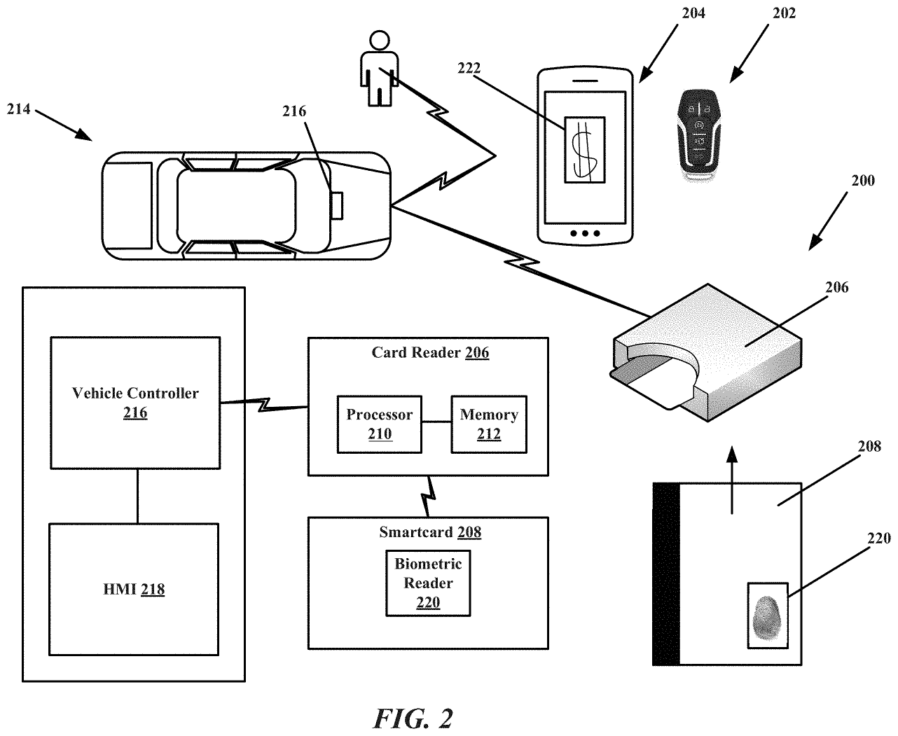

FIG. 2 illustrates another environment having a configuration of a physical key 200 that can be used in place of (or in combination with a key fob 202 or mobile device 204). In general, the physical key 200 can be configured to read biometric information of a user. The physical key 200 can be used when a legacy physical key (e.g., a key with no computing capabilities) or the user desires to use PaaK (e.g., mobile device 204 as a key). The physical key 200 can provide identity and mode management as disclosed above.

The physical key 200 could include a card reader 206 and a smartcard 208. The card reader 206 can comprise a processor 210 and a memory 212 for storing identity and mode management logic. The card reader 206 can operate as a standalone device or can be integrated into a vehicle 214. For example, the card reader 206 could be installed into a dashboard or console of the vehicle 214. Alternatively, the card reader 206 could be a standalone device that can be communicatively coupled with a vehicle controller 216 and/or the mobile device 204. The communicative coupling could occur through a wired or wireless connection.

In operation, when the user is using their mobile device 204 as a PaaK, the user can initiate enrollment of the mobile device 204 using a menu option provided on a human machine interface 218 of the vehicle 214. Presence of their PaaK mobile device 204 or a key fob (not shown) within the vehicle 214 allows for pairing of the PaaK mobile device 204 with the vehicle controller 216.

The vehicle controller 216 can then prompt the user to place their smartcard 208 near the card reader 206, for both communication and power, and place their finger on a biometric reader 220 of the smartcard 208 at a variety of positions. The card reader 206 can use these images to train a recognition model. Feedback indicating that the images have been properly captured can be provided to the user on any of the mobile device 204, the card reader 206, or the human machine interface 218. For example, an LED (light emitting diode) can be used to identify the quality of image captures. A high quality image capture could result in the LED flashing green, whereas low confidence captures may flash red.

The smartcard 208 can include a dedicated smartcard used for accessing the vehicle 214. Alternatively, the smartcard 208 can include a credit card that the user enrolls for use into the system. This allows the user to utilize a smartcard that they may frequently carry to be used to authenticate their identity, rather than using a single-purpose smartcard.

As noted above, the user can also enroll a digital signature 222 used to authenticate the user. The digital signature can be provided by the user into the biometric reader 220 of the smartcard 208, or alternatively through the PaaK mobile device 204. In this example, the digital signature 222 is provided through the PaaK mobile device 204, in the form of a dollar sign. Also, the card reader 206 can be configured to provide the Bayesian image analysis and/or power optimization features disclosed above.

Each of the embodiments disclosed above contemplate allowing multiple users to enroll and use the same or multiple physical keys. Valid users may also choose to un-enroll users. This use case would be to account for sale of the vehicle. To un-enroll users, an administrative user, such as the vehicle owner, can select an un-enroll option from a menu or user interface provided on the human machine interface 218, for example. Authentication via fingerprint of the administrative user may be requested prior to an un-enroll process.

The administrative user can be presented an option to un-enroll all users, or a specific users. Complete un-enrollment may also be accomplished which would wipe clean the memory 212 of the card reader 206 (or other similar physical key). Un-enrolling specific users may include first authenticating the users via the physical key's fingerprint sensor, which protects the users' privacy (e.g., direct access to the biometrics may never be allowed). Once their fingerprint is recognized, a prompt may be provided to confirm user deletion.

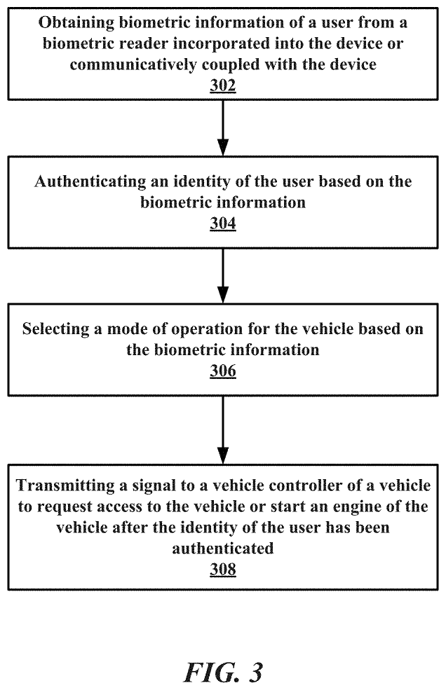

FIG. 3 illustrates an example flowchart of a method of the present disclosure. In this method, a physical key and vehicle controller cooperate to perform the method. The method can include a step 302 of obtaining biometric information of a user from a biometric reader incorporated into the device or communicatively coupled with the device. As noted above, this can include obtaining a fingerprint or other similar biometric information from physical key of the vehicle. The physical key can include a smart key fob, a PaaK, or a card reader/smartcard combination.

The method can also include a step 304 of authenticating an identity of the user based on the biometric information. This can include comparing the biometric information to stored biometric information using, for example, Bayesian analysis, along with filtering. The method may also include a step 306 of selecting a mode of operation for the vehicle based on the biometric information. The mode of operation can specify vehicle privileges for the user. That based on the mode of operation, a range of vehicle privileges can be selected for a user, which can include full or limited privileges. Once the user has been authenticated and a mode selected, the method can include a step 308 of transmitting a signal to a vehicle controller of a vehicle to request access to the vehicle or start an engine of the vehicle after the identity of the user has been authenticated. It will be understood that selecting a mode of operation for user is not required, and that the aspects of user authentication can be used alone. This method allows for differentiation between users who may use a single physical key for a vehicle or even in instances where multiple keys for the same vehicle are used by a plurality of users.

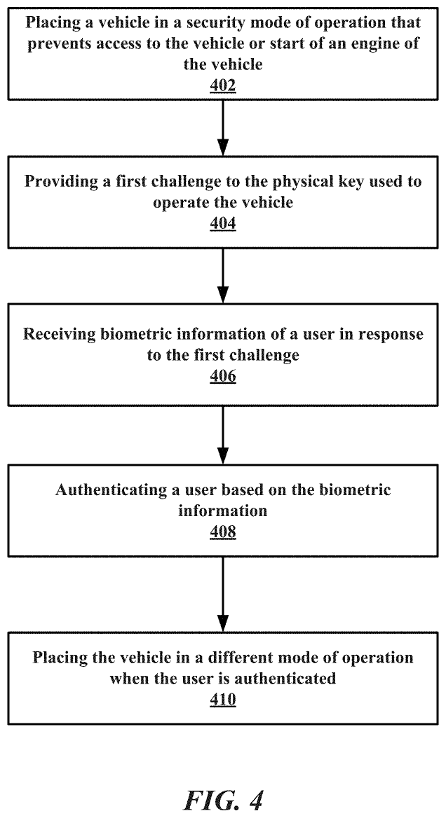

FIG. 4 is a flowchart of an example method performed from at the vehicle controller level. That is, while some embodiment herein contemplate authentication and mode control being performed at the physical key level, authentication and mode control can alternatively be implemented at the vehicle controller level.

The method can include a step 402 of placing a vehicle in a security mode of operation that prevents access to the vehicle or start of an engine of the vehicle. Thus, the vehicle would be set to ignore requests from devices, such as physical keys, to access or start the vehicle. If a driver or user desires to access or start the vehicle, the user could transmit a signal to the vehicle, such as an unlock request. In response, the method can include a step 404 of providing a first challenge to the physical key used to operate the vehicle. The method can further include a step 406 of receiving biometric information of a user in response to the first challenge. Once the biometric information is received, the method can include a step 408 of authenticating a user based on the biometric information, as well as a step 410 of placing the vehicle in a different mode of operation when the user is authenticated. As noted above, the different mode of operation could include an active mode, a limited mode, a shared mode, and so forth.

As noted above, prior to executing either the method of FIG. 3 or 4, each method can include steps such as pairing a physical key and a vehicle controller and enrolling user(s). A step of receiving the biometric information of the user can be used, along with a step of receiving a digital touch signature from a touch sensor of the physical key. The method can also include a step of creating a profile for the user that includes the biometric information of the user, the digital touch signature, the profile linking the user to the physical key. As noted above, the each user of a vehicle can be linked with a unique physical key. Each unique physical key can be represented by an identifier. When a physical key is encountered by the vehicle controller, the identifier for the physical key can be used to identify user profiles associated with that key. These profiles can be used to compare received biometric information during an identity challenge, for example.

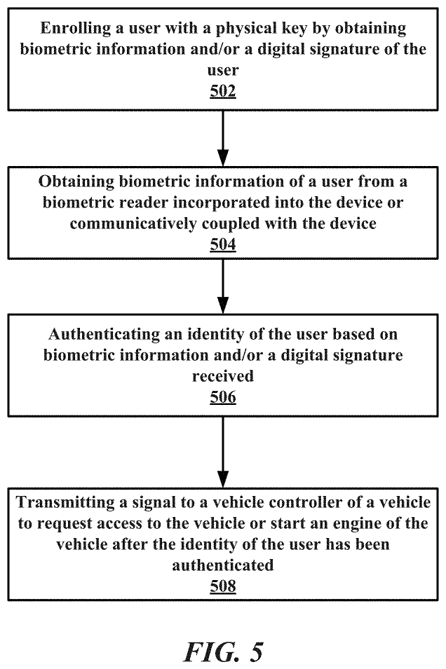

FIG. 5 illustrates an example flowchart of a method of the present disclosure. The method can include a step 502 of enrolling a user with a physical key by obtaining biometric information and/or a digital signature of the user. A user profile can be created and stored on the physical key in some instances.

When the user desires to access or start the vehicle associated with the physical key, the method can include a step 504 of obtaining biometric information of a user from a biometric reader incorporated into the device or communicatively coupled with the device. The method can also include a step 506 of authenticating an identity of the user based on biometric information and/or a digital signature received. To be sure, step 506 can include receiving the biometric information and digital signature during an access or start request, as opposed to the initial receiving of the biometric information and/or a digital signature used to enroll the user.

The method can include a step 508 of transmitting a signal to a vehicle controller of a vehicle to request access to the vehicle or start an engine of the vehicle after the identity of the user has been authenticated. Again, this authentication can be based on a comparison of the biometric information and/or a digital signature obtained to the biometric information and/or a digital signature(s) stored on the physical key when the user was enrolled.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A device, comprising:
a processor; and
a memory for storing instructions for identify management, the processor executing the instructions to:
obtain biometric information of a user from a biometric reader incorporated into the device or communicatively coupled with the device;
authenticate an identity of the user based on the biometric information;
select a mode of operation for a vehicle based on the biometric information, the mode of operation specifying vehicle privileges for the user; and
transmit a signal to a vehicle controller of the vehicle to request access to the vehicle or start an engine of the vehicle after the identity of the user has been authenticated.

2. The device according to claim 1, wherein the mode of operation is a security mode prior to the identity of the user being authenticated, further wherein the mode of operation is switched to an active mode when the identity of the user is authenticated, the active mode allowing the device and the vehicle to remain in an authenticated state for a period of time or for a number of drive cycles.

3. The device according to claim 2, wherein the mode of operation comprises a limited mode for the user, the limited mode providing the user with a limited set of vehicle features relative to a complete set of vehicle features available to a different user.

4. The device according to claim 3, wherein the vehicle controller is configured to allow an administrative user to select the limited set of vehicle features.

5. The device according to claim 1, wherein the processor is configured to:
receive an identity challenge request based on detection of an anomaly; and
receive the biometric information of the user a second time; and
re-authenticate the user based on the biometric information.

6. The device according to claim 1, wherein the processor is configured to:
receive the biometric information a second time when the device is in a shared mode; and
place the device in a different mode than the shared mode when the biometric information is authenticated and the biometric information is associated with a user who has active mode access.

7. The device according to claim 1, wherein the device comprises a smartcard and a card reader that receives the smartcard, the biometric reader being incorporated into the smartcard.

8. The device according to claim 7, wherein the biometric reader functions as a touch sensor, wherein the user can establish a digital touch signature used for authenticating the identity of the user using the biometric reader.

9. The device according to claim 1, wherein the biometric reader is integrated into a housing of the device, the device being a physical key.

10. A method, comprising:
obtaining biometric information or a digital signature of a user from a biometric reader;
authenticating an identity of the user based on the biometric information or the digital signature;
selecting a mode of operation for a vehicle based on the biometric information, the mode of operation specifying vehicle privileges for the user; and
transmitting a signal to a vehicle controller of the vehicle to request access to the vehicle or start an engine of the vehicle after the identity of the user has been authenticated.

11. The method according to claim 10, further comprising, prior to obtaining the biometric information or the digital signature, enrolling a user with a physical key that is associated with the biometric reader, wherein enrolling includes storing the biometric information and the digital signature of the user, further wherein authenticating includes comparing the stored biometric information and the stored digital signature are against the obtained biometric information or the digital signature.

12. The method according to claim 10, further comprising:
wherein selecting a mode of operation comprises placing the vehicle in a limited mode or a shared mode; and
placing the vehicle in an active mode when the user provides the biometric information through a physical key when in the limited mode or the shared mode, wherein the physical key comprises the biometric reader.

13. The method according to claim 12, wherein the active mode includes a limited role that restricts access to at least a portion of vehicle features of the vehicle.

14. The method according to claim 10, wherein the user is one of a plurality of users, at least a portion of the plurality of users being allow to use the vehicle in a limited mode.

15. A vehicle controller, comprising:
a processor; and
a memory for storing executable instructions for identify management, the processor executing the instructions to:
place a vehicle in a security mode of operation that prevents access to the vehicle or start of an engine of the vehicle;
provide a first challenge to a physical key used to operate the vehicle;
receive biometric information of a user in response to the first challenge;
authenticate a user based on the biometric information; and
place the vehicle into a different mode of operation when the user is authenticated, the different mode of operation allowing access to the vehicle or starting of the engine of the vehicle.

16. The vehicle controller according to claim 15, wherein the processor is configured to place the vehicle into a shared mode where a physical key of the vehicle can be shared between the user and another user.

17. The vehicle controller according to claim 16, wherein the processor is configured to return the vehicle into an active mode after the user provides the biometric information when the vehicle is in the shared mode and the biometric information is authenticated again.

18. The vehicle controller according to claim 15, wherein the processor is configured to:
detect an anomaly that is indicative of malicious activity;
provide a second challenge to the physical key;
receive the biometric information of the user in response to the second challenge; and
re-authenticate the user based on the biometric information.

19. The vehicle controller according to claim 15, wherein the processor is configured to enroll the user by obtaining the biometric information of the user prior to the first challenge.

20. The vehicle controller according to claim 15, wherein the processor enrolls the user by:
pairing with the physical key;
receiving the biometric information of the user;
receiving a digital touch signature from a touch sensor of the physical key; and
creating a profile for the user that includes the biometric information of the user, the digital touch signature, the profile linking the user to the physical key.
